(19) United States
(12) Patent Application Publication
(10) Pub. No.: US 2018/0141591 A1
(43) Pub. Date: May 24, 2018

(54) VEHICLE SIDE STRUCTURE

(71) Applicant: TOYOTA JIDOSHA KABUSHIKI KAISHA, Toyota-shi (JP)

(72) Inventor: Masahiro URAGO, Toyota-shi (JP)

(73) Assignee: TOYOTA JIDOSHA KABUSHIKI KAISHA, Toyota-shi (JP)

(21) Appl. No.: 15/815,906

(22) Filed: Nov. 17, 2017

(30) Foreign Application Priority Data
Nov. 22, 2016 (JP) 2016-227084

(51) Int. Cl. B62D 27/02; B62D 25/02; B62D 25/06

(52) U.S. Cl. CPC B62D 27/02; B62D 25/06; B62D 25/025

(57) ABSTRACT

The present invention provides a vehicle side structure including: a center pillar extended along a vehicle up-down direction at a vehicle side part, the center pillar comprising a center pillar outer panel disposed at an outer side in a vehicle width direction; a roof side rail provided at a vehicle upper side of the center pillar, the roof side rail being extended along a vehicle front-rear direction and comprising a roof side rail outer panel disposed at an outer side in the vehicle width direction; a joining section at which an inner side surface, in the vehicle width direction, of an upper section of the center pillar outer panel in the vehicle up-down direction, and an outer side surface of the roof side rail outer panel in the vehicle width direction, are overlapped and joined; and a load transfer section formed at the center pillar outer panel and configured in a shape projecting toward a vehicle outer side from the joining section.

### CROSS-REFERENCE TO RELATED APPLICATION

This application is based upon and claims the benefit of priority of the prior Japanese Patent Application No. 2016-227084, filed on Nov. 22, 2016, the entire contents of which are incorporated herein by reference.

### FIELD

The embodiments discussed herein are related to a vehicle side structure.

### BACKGROUND

Patent Document 1 (Japanese Patent Application Laid-Open Publication No. 2008-132923) discloses a structure in which an upper end section of a center pillar outer panel is joined to a surface facing a vehicle interior outer side of a roof side rail outer panel, and an upper end section of a center pillar inner panel is joined to a panel lower section of a surface facing a vehicle interior inner side of a roof side rail inner panel.

Note that a structure described in Patent Document 2 (Japanese Patent Application Laid-Open Publication No. 2013-233918) may be cited as a structure that includes on a surface of the roof side rail inner panel disposed on an inner side in a vehicle width direction of the roof side rail outer panel a load transfer section formed in a shape projecting toward the roof side rail outer panel.

In the structure described in Patent Document 1 (Japanese Patent Application Laid-Open Publication No. 2008-132923), in the case where, for example, the roof side rail outer panel is manufactured by a hot stamp material (HS material), it is difficult, in terms of a molding requirement (for example, a mold viability requirement) of the panel, for an angle with respect to a horizontal direction of a top plate surface of the roof side rail outer panel to be made substantially the same as an angle with respect to the horizontal direction of a contact surface of a collision testing device. In other words, because the contact surface of the collision testing device and the top plate surface of the roof side rail outer panel are not parallel, the roof side rail outer panel, by being pressed by the collision testing device, undergoes rotational deformation to a vehicle inner side, and load transfer efficiency to a center pillar lowers. Therefore, in the above-described structure, there is a possibility of it becoming difficult to support a target load, and there is room for improvement.

### SUMMARY

In view of the above-described facts, the present invention has an object of obtaining a vehicle side structure that can suppress rotational deformation of a roof side rail outer panel during a roof crash and raise load transfer efficiency to a center pillar.

A vehicle side structure according to a first aspect includes: a center pillar extended along a vehicle up-down direction at a vehicle side part, the center pillar comprising a center pillar outer panel disposed at an outer side in a vehicle width direction; a roof side rail provided at a vehicle upper side of the center pillar, the roof side rail being extended along a vehicle front-rear direction and comprising a roof side rail outer panel disposed at an outer side in the vehicle width direction; a joining section at which an inner side surface, in the vehicle width direction, of an upper section of the center pillar outer panel in the vehicle up-down direction, and an outer side surface of the roof side rail outer panel in the vehicle width direction, are overlapped and joined; and a load transfer section formed at the center pillar outer panel and configured in a shape projecting toward a vehicle outer side from the joining section.

Due to the vehicle side structure described in the first aspect, a center pillar extended along a vehicle up-down direction at a vehicle side part includes a center pillar outer panel disposed at an outer side in a vehicle width direction. A roof side rail extended along a vehicle front-rear direction is provided at a vehicle upper side of the center pillar, and the roof side rail includes a roof side rail outer panel disposed at an outer side in the vehicle width direction. Moreover, an inner side surface in the vehicle width direction of an upper section of the center pillar outer panel and an outer side surface in the vehicle width direction of the roof side rail outer panel are overlapped and joined, whereby a joining section is provided. A load transfer section configured in a shape projecting toward a vehicle outer side from the joining section is formed at the center pillar outer panel. As a result, when an upper section of the vehicle side has been pressed by a contact surface of a collision testing device, a virtual surface configured by the load transfer section and a ridge on a vehicle upper side of the roof side rail outer panel approaches becoming parallel to the contact surface of the collision testing device, based on a projection amount of the load transfer section. Therefore, in the above-described configuration, it is more suppressed that the roof side rail outer panel undergoes rotational deformation to a vehicle inner side by being pressed by a corresponding contact surface during a roof crash, compared to in a configuration where there is no load transfer section projecting to a vehicle outer side. Therefore, it is suppressed that the center pillar deforms by collapsing to an inner side in the vehicle width direction along with rotational deformation of the roof side rail, and load transfer efficiency to the center pillar can be raised.

A vehicle side structure according to a second aspect is the vehicle side structure described in the first aspect, wherein the load transfer section is configured as a projecting section projecting from the joining section and is formed along a lower end side of the joining section.

Due to the vehicle side structure described in the second aspect, a projecting section projecting from the joining section of the center pillar outer panel is formed along a lower end side of the joining section. As a result, a distance of a virtual surface configured by the projecting section and a ridge on a vehicle upper side of the roof side rail outer panel widens, and a deformation mode of the roof side rail outer panel when it has been pressed by a corresponding contact surface during a roof crash, stabilizes.

A vehicle side structure according to a third aspect includes: a center pillar extended along a vehicle up-down direction at a vehicle side part, the center pillar comprising a center pillar outer panel disposed at an outer side in a vehicle width direction; and a roof side rail provided at a vehicle upper side of the center pillar, the roof side rail being extended along a vehicle front-rear direction and comprising a roof side rail outer panel disposed at an outer side in the vehicle width direction, in a case in which, in a Roof Strength Test conducted by the United States Insurance Institute for Highway Safety, a contact surface of a collision testing device has been pressed at an angle of 25° with respect to a horizontal direction from an outer side in the vehicle width direction toward an obliquely downward side at an inner side in the vehicle width direction of the roof side rail in vehicle front view, a joining section, at which an inner side surface, in the vehicle width direction, of an upper section of the center pillar outer panel in the vehicle up-down direction, and an outer side surface of the roof side rail outer panel in the vehicle width direction, are overlapped and joined, being configured so as to be substantially parallel to the contact surface in vehicle front view.

Now, the Roof Strength Test conducted by the United States Insurance Institute for Highway Safety (IIHS) refers to a test for evaluating whether a load of four times a weight of a vehicle can be tolerated when a contact surface of a collision testing device has been pressed from an outer side in a vehicle width direction toward an obliquely downward side on an inner side in the vehicle width direction of a roof side rail (refer to Roof Strength Test Protocol (Ver. III) July 2016, 2016 IIHS internet homepage (http://www.iihs.org/iihs/ratings/ratings-info/roof-strength-test)). In the Roof Strength Test, the contact surface of the collision testing device is set so as to press on the roof side rail at an angle of 25° with respect to a horizontal direction, in vehicle front view.

Due to the vehicle side structure described in the third aspect, a center pillar extended along a vehicle up-down direction at a vehicle side part includes a center pillar outer panel disposed on an outer side in a vehicle width direction. A roof side rail extended along a vehicle front-rear direction is provided at a vehicle upper side of the center pillar, and the roof side rail includes a roof side rail outer panel disposed at an outer side in the vehicle width direction. Furthermore, in the case that in a Roof Strength Test conducted by the United States Insurance Institute for Highway Safety, a contact surface of a collision testing device has been pressed at an angle of 25° with respect to a horizontal direction from an outer side in the vehicle width direction toward an obliquely downward side on an inner side in the vehicle width direction of the roof side rail in vehicle front view, a joining section where there are overlapped and joined an inner side surface in the vehicle width direction of an upper section of the center pillar outer panel in the vehicle up-down direction and an outer side surface of the roof side rail outer panel in the vehicle width direction is configured so as to be substantially parallel to the contact surface of the collision testing device in vehicle front view. As a result, it is suppressed that the roof side rail outer panel undergoes rotational deformation to the vehicle inner side by the joining section of the center pillar outer panel and the roof side rail outer panel being pressed by a corresponding contact surface during a roof crash. Therefore, it is suppressed that the center pillar deforms by collapsing to an inner side in the vehicle width direction along with rotational deformation of the roof side rail, and load transfer efficiency to the center pillar can be raised.

A vehicle side structure according to a fourth aspect is the vehicle side structure described in the first aspect, wherein in a case in which, in a Roof Strength Test conducted by the United States Insurance Institute for Highway Safety, a contact surface of a collision testing device has been pressed at an angle of 25° with respect to a horizontal direction from an outer side in the vehicle width direction toward an obliquely downward side at an inner side in the vehicle width direction of the roof side rail in vehicle front view, a virtual surface, configured by the load transfer section and a ridge at a vehicle upper side of the roof side rail outer panel, is configured so as to be substantially parallel to the contact surface in vehicle front view.

Due to the vehicle side structure described in the fourth aspect, a virtual surface configured by the load transfer section and a ridge at a vehicle upper side of the roof side rail outer panel is configured so as to be substantially parallel to the contact surface of the collision testing device in vehicle front view. As a result, it is suppressed that the roof side rail outer panel undergoes rotational deformation to a vehicle inner side by the load transfer section and the ridge on the vehicle upper side of the roof side rail outer panel being pressed by a corresponding contact surface during a roof crash. Therefore, it is suppressed that the center pillar deforms by collapsing to an inner side in the vehicle width direction along with rotational deformation of the roof side rail, and load transfer efficiency to the center pillar can be raised.

Now, in the vehicle side structure described in the third aspect or the fourth aspect, “parallel” includes not only the case where the joining section is completely parallel to the contact surface in vehicle front view, but also the case where the joining section is substantially parallel to the contact surface in vehicle front view, that is, where an angle with respect to the horizontal direction of the joining section is slightly misaligned from an angle with respect to the horizontal direction of the contact surface (the case where, for example, the angles are misaligned by from −5° to +5°).

The vehicle side structure according to the present disclosure makes it possible to suppress rotational deformation of a roof side rail outer panel during a roof crash and raise load transfer efficiency to a center pillar.

### BRIEF DESCRIPTION OF DRAWINGS

FIG. 1 is a side view showing a side section of a vehicle applied with a vehicle side structure according to a first embodiment.

FIG. 2 is a cross-sectional view (a cross-sectional view taken along the line 2-2 in FIG. 1) showing a joining section of a center pillar and a roof side rail applied with the vehicle side structure according to the first embodiment.

FIG. 3 is a cross-sectional view showing a joining section of a center pillar and a roof side rail applied with a vehicle side structure according to a second embodiment.

FIG. 4 is a cross-sectional view showing a joining section of a center pillar and a roof side rail applied with a vehicle side structure according to a third embodiment.

FIG. 5 is a cross-sectional view showing a joining section of a center pillar and a roof side rail applied with a vehicle side structure according to a comparative example.

FIG. 6 is a schematic cross-sectional view comparing a first deformation state due to a collision test, in the vehicle side structure shown in FIG. 3 and the vehicle side structure shown in FIG. 5.

FIG. 7 is a schematic cross-sectional view comparing a second deformation state due to a collision test, in the vehicle side structure shown in FIG. 3 and the vehicle side structure shown in FIG. 5.

FIG. 8 is a graph comparing a relationship of a stroke of a collision testing device and a device reaction force, in the vehicle side structure shown in FIG. 3 and the vehicle side structure shown in FIG. 5.

FIG. 9 is a graph comparing a relationship of a stroke of a collision testing device and a load in an up-down direction of the center pillar, in the vehicle side structure shown in FIG. 3 and the vehicle side structure shown in FIG. 5.

### DESCRIPTION OF EMBODIMENTS

Embodiments of the present invention will be described in detail based on the drawings. Note that regarding arrows FR, UP, and OUT appropriately indicated in these drawings, the arrow FR indicates a vehicle front side, the arrow UP indicates a vehicle upper side, and the arrow OUT indicates an outer side in a vehicle width direction.

### First Embodiment

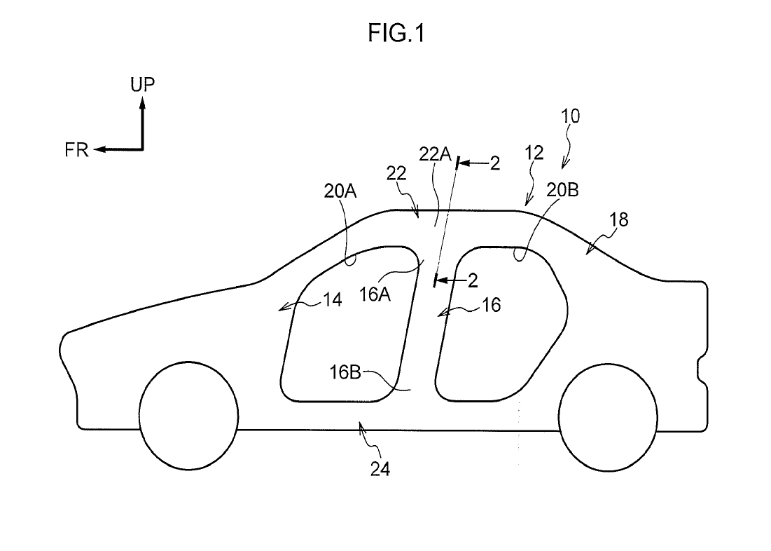

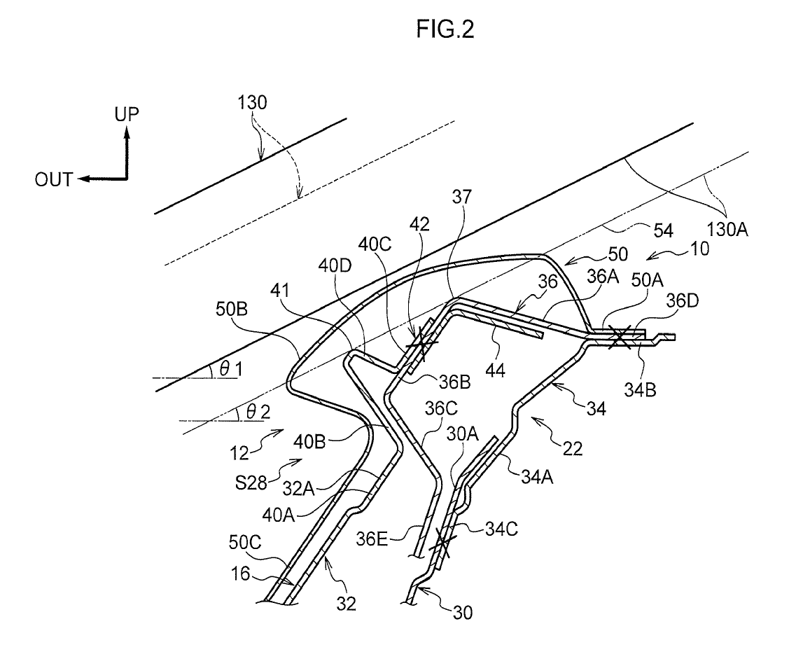

A vehicle side structure according to a first embodiment will be described below using FIGS. 1 and 2.

FIG. 1 shows in a schematic side view a side section 12 of a vehicle 10 applied with a vehicle side structure S28 (refer to FIG. 2) of the first embodiment. As shown in FIG. 1, a front pillar 14, a center pillar 16, and a rear pillar 18 are arranged in order from the vehicle front side, in the side section 12 of the vehicle 10. Note that the front pillar 14, the center pillar 16, and the rear pillar 18 are provided as a left and right pair on both sides of the vehicle 10. The center pillar 16 is disposed between a front door opening 20A and a rear door opening 20B formed in the side section 12 of the vehicle 10, and is extended along substantially a vehicle up-down direction. That is, the center pillar 16 is configured as a vehicle body frame member having as its longitudinal direction substantially the vehicle up-down direction.

A roof side rail 22 extended in substantially a vehicle front-rear direction is provided on an upper section side of the center pillar 16. An upper end section 16A of the center pillar 16 is joined to an intermediate section 22A in the vehicle front-rear direction in the roof side rail 22. The roof side rail 22 is configured as a vehicle body frame member disposed having as its longitudinal direction substantially the vehicle front-rear direction, on both sides of a roof panel (illustration omitted) disposed in substantially the vehicle width direction and substantially the vehicle front-rear direction in a vehicle upper section. That is, the roof side rail 22 is disposed in substantially the vehicle front-rear direction along upper edges of the front door opening 20A and the rear door opening 20B. A joining section of the center pillar 16 and the roof side rail 22 is formed in substantially a T shape. Moreover, a front end section of the roof side rail 22 is joined to the front pillar 14, and a rear end section of the roof side rail 22 is joined to the rear pillar 18.

In addition, a lower end section 16B of the center pillar 16 is joined to an intermediate section in the vehicle front-rear direction in a rocker 24. The rocker 24 is configured as a vehicle body frame member disposed having as its longitudinal direction substantially the vehicle front-rear direction on both sides of a lower section of the vehicle 10. That is, the rocker 24 is disposed in substantially the vehicle front-rear direction along lower edges of the front door opening 20A and the rear door opening 20B.

FIG. 2 shows in a cross-sectional view (a cross-sectional view taken along the line 2-2 in FIG. 1) an upper section of the side section 12 of the vehicle 10 applied with the vehicle side structure S28 of the first embodiment. Note that FIG. 2 shows a left side end section in a width direction of the vehicle 10 in vehicle rear view, but a right side end section in the width direction of the vehicle 10 is left-right symmetrical to this, hence illustration thereof is omitted. As shown in FIG. 2, the center pillar 16 includes: a center pillar inner panel 30 disposed on an inner side in the vehicle width direction; and a center pillar outer panel 32 disposed on an outer side in the vehicle width direction of the center pillar inner panel 30. In addition, the roof side rail 22 includes: a roof side rail inner panel (hereafter, abbreviated to “rail inner panel”) 34 disposed on an inner side in the vehicle width direction; and a roof side rail outer panel (hereafter, abbreviated to “rail outer panel”) 36 disposed on an outer side in the vehicle width direction of the rail inner panel 34. Moreover, a side member outer (also called a side outer panel) 50 is disposed further on an outer side in the vehicle width direction of the rail outer panel 36 and the center pillar outer panel 32.

The rail inner panel 34 configures a part on an inner side in the vehicle width direction of the roof side rail 22, and is disposed having as its longitudinal direction the vehicle front-rear direction, in the vehicle upper section. The rail inner panel 34 includes: a side wall section 34A disposed in an oblique direction such that its inner side portion in the vehicle width direction is more to an upper side than its outer side portion in the vehicle width direction; and an upper flange section 34B extending to an inner side in the vehicle width direction from an upper end section of the side wall section 34A. Furthermore, the rail inner panel 34 includes a lower flange section 34C extending obliquely downwardly to an outer side in the vehicle width direction from a lower end section of the side wall section 34A.

The rail outer panel 36 configures a part on an outer side in the vehicle width direction of the rail inner panel 34, and is disposed having as its longitudinal direction the vehicle front-rear direction, in the vehicle upper section. The rail outer panel 36 has its cross section configured as substantially a hat shape in a cross-sectional view along substantially the vehicle up-down direction and substantially the vehicle width direction, and is opened inwardly orientated in the vehicle width direction. More specifically, the rail outer panel 36 includes: an upper wall section 36A disposed along substantially the vehicle width direction; an outer side wall section 36B disposed along an obliquely downward direction to an outer side in the vehicle width direction from an end section on an outer side in the vehicle width direction of the upper wall section 36A; and a lower wall section 36C disposed along an obliquely downward direction to an inner side in the vehicle width direction from a lower end section of the outer side wall section 36B. Furthermore, the rail outer panel 36 includes: an upper flange section 36D extending to an inner side in the vehicle width direction from an end section on an inner side in the vehicle width direction of the upper wall section 36A; and a lower flange section 36E extending substantially obliquely downwardly to an outer side in the vehicle width direction from an end section on an inner side in the vehicle width direction of the lower wall section 36C. The upper wall section 36A is disposed such that its outer side portion in the vehicle width direction is slightly more to an upper side than its inner side portion in the vehicle width direction.

The upper flange section 36D of the rail outer panel 36 is overlapped on to be joined by welding to an upper surface of the upper flange section 34B of the rail inner panel 34. In addition, a flange section 50A formed in an end section on an inner side in the vehicle width direction of an upper section of the side member outer 50 is overlapped on to be joined by welding to an upper surface of the upper flange section 36D of the rail outer panel 36. Although illustration thereof is omitted, for example, an end section on an outer side in the vehicle width direction of the roof panel is overlapped on to be joined by welding to an upper surface of the flange section 50A of the side member outer 50.

The rail outer panel 36 is formed by, for example, press working high tensile strength steel sheets or a hot stamp material (HS material) which is ultra-high tensile strength steel sheets. Now, a high tensile strength steel sheet means a steel sheet whose tensile strength is higher than that of an ordinary steel sheet, and mainly refers to a steel sheet whose tensile strength is 440 MPa or more. Moreover, an ultra-high tensile strength steel sheet refers to a high tensile strength steel sheet whose tensile strength is 980 MPa or more.

The center pillar inner panel 30 is disposed having as its longitudinal direction substantially the vehicle up-down direction, and an upper end section 30A of the center pillar inner panel 30 is disposed on an outer side in the vehicle width direction of the rail inner panel 34. Part of the upper end section 30A of the center pillar inner panel 30 is overlapped on to be joined by welding to the lower flange section 34C of the rail inner panel 34. Although illustration thereof is omitted, the center pillar inner panel 30 has its cross-sectional shape along a horizontal direction (substantially the vehicle width direction and substantially the vehicle front-rear direction) configured as substantially a hat shape opened inwardly orientated in the vehicle width direction. A projecting surface projecting to an inner side in the vehicle width direction, of the center pillar inner panel 30 is overlapped on to be joined to the lower flange section 34C of the rail inner panel 34.

The center pillar outer panel 32 is disposed having as its longitudinal direction substantially the vehicle up-down direction, and an upper end section 32A of the center pillar outer panel 32 is disposed on an outer side in the vehicle width direction of the rail outer panel 36. More specifically, the upper end section 32A of the center pillar outer panel 32 includes: a wall section 40A disposed in an oblique direction such that substantially its vehicle upper side is to an inner side in the vehicle width direction; and an inclined wall section 40B extending obliquely upwardly to an outer side in the vehicle width direction from an upper end section of the wall section 40A. The wall section 40A is disposed with a spacing between itself and the lower flange section 36E of the rail outer panel 36. The inclined wall section 40B is disposed along the lower wall section 36C of the rail outer panel 36 with a spacing between itself and the lower wall section 36C.

Furthermore, the upper end section 32A of the center pillar outer panel 32 includes: a projecting section 40D acting as a load transfer section configured in a shape projecting to a vehicle outer side from the inclined wall section 40B; and a flange section 40C bent from an end section on an inner side in the vehicle width direction of the projecting section 40D to be overlapped on the outer side wall section 36B of the rail outer panel 36. The flange section 40C is bent from the end section on an inner side in the vehicle width direction of the projecting section 40D to extend obliquely upwardly to an inner side in the vehicle width direction. An inner side surface in the vehicle width direction of the flange section 40C and an outer side surface in the vehicle width direction of the outer side wall section 36B of the rail outer panel 36 are overlapped, whereby a joining section (in the present embodiment, an overlapping section) 42 is configured (formed). In the joining section 42, the flange section 40C and the outer side wall section 36B are joined by welding.

A stiffening plate 44 formed in substantially an L shape is disposed on an inner side in the vehicle width direction of the rail outer panel 36 (in a cross section of the rail outer panel 36), and one end section of the stiffening plate 44 is overlapped on an inner side surface in the vehicle width direction of the outer side wall section 36B of the rail outer panel 36. Moreover, the flange section 40C of the center pillar outer panel 32, the outer side wall section 36B of the rail outer panel 36, and the stiffening plate 44 are joined by welding. Note that in the vehicle side structure S28, a shape of the stiffening plate 44 may be changed, or there may be a configuration in which the stiffening plate 44 is not provided.

The projecting section 40D is formed in substantially an inverse U shape, and is configured in a shape projecting toward the vehicle outer side (in the first embodiment, obliquely upwardly to an outer side in the vehicle width direction) from a lower end section of the flange section 40C. A lower end of the projecting section 40D is configured continuous with an upper end of the inclined wall section 40B. The projecting section 40D is formed along a lower end side of the flange section 40C. In other words, the projecting section 40D is configured in a shape projecting from the joining section 42 of the center pillar outer panel 32 and the rail outer panel 36, and is formed along a lower end side of the joining section 42. The wall section 40A, the inclined wall section 40B, the projecting section 40D, and the flange section 40C are extended along substantially the vehicle front-rear direction.

In the vehicle side structure S28, a virtual surface 54 configured by a top (in the first embodiment, a corner 41 on an upper side) of the projecting section 40D and a ridge 37 on a vehicle upper side of the rail outer panel 36, is configured inclined such that its outer side in the vehicle width direction is to a vehicle lower side. At that time, the above-described virtual surface 54 is configured so as to get close to parallel to a contact surface 130A of a collision testing device 130 used in a Roof Strength Test. In the first embodiment, the virtual surface 54 shown in FIG. 2 is configured so as to be substantially parallel to the contact surface 130A of the collision testing device 130. Specifically, an angle θ1 with respect to the horizontal direction of a later-mentioned solid line contact surface 130A of the collision testing device 130 is 25° in vehicle front view (in vehicle rear view in FIG. 2), and an angle θ2 with respect to the horizontal direction of the above-described virtual surface 54 is configured to be approximately 25° in vehicle front view (in vehicle rear view in FIG. 2).

In the Roof Strength Test which is conducted by the United States Insurance Institute for Highway Safety (IIHS), it is evaluated whether a load of four times a weight of the vehicle can be tolerated when the contact surface of the collision testing device has been pressed from an outer side in the vehicle width direction toward an obliquely downward side on an inner side in the vehicle width direction of the roof side rail (refer to Roof Strength Test Protocol (Ver. III) July 2016, 2016 IIHS internet homepage (http://www.iihs.org/iihs/ratings/ratings-info/roof-strength-test)). In the Roof Strength Test, the contact surface of the collision testing device is set so as to be pressed on the roof side rail with the angle θ1 with respect to the horizontal direction of the contact surface being 25° in vehicle front view.

FIG. 2 shows a time of contact to the vehicle 10 of the solid line contact surface 130A of the collision testing device 130. The side member outer 50 is curved such that its intermediate section in the vehicle front-rear direction protrudes to the vehicle upper side, and in a position of FIG. 2, a gap slightly exists between the solid line contact surface 130A and the side member outer 50. Moreover, FIG. 2 shows a time of contact to the roof side rail 22 of a two dot-chain line contact surface 130A of the collision testing device 130.

In the vehicle side structure S28, by the above-described virtual surface 54 being configured so as to be substantially parallel to the contact surface 130A of the collision testing device 130, rotational deformation to a vehicle inner side of the rail outer panel 36 when the roof side rail 22 is pressed by the contact surface 130A of the collision testing device 130 is configured to be suppressed.

Although illustration thereof is omitted, the upper end section 32A of the center pillar outer panel 32 is configured in a shape curving such that its intermediate section in substantially the vehicle front-rear direction protrudes to the vehicle upper side. Moreover, although illustration thereof is omitted, a lower side in the vehicle up-down direction from the wall section 40A of the center pillar outer panel 32 has its cross-sectional shape along the horizontal direction configured in substantially a hat shape opened inwardly orientated in the vehicle width direction. The wall section 40A shown in FIG. 2 is configured as a portion protruding to an outer side in the vehicle width direction of the center pillar outer panel 32. Note that a front-rear pair of terminal sections in the vehicle front-rear direction of the center pillar outer panel 32 are overlapped on to be joined by the likes of welding to a front-rear pair of terminal sections in the vehicle front-rear direction of the center pillar inner panel 30, whereby a closed cross section is configured.

As shown in FIG. 2, the side member outer 50 includes a convex section 50B that projects to an outer side in the vehicle width direction from the flange section 50A so as to cover the rail outer panel 36 and the upper end section 32A of the center pillar outer panel 32. The side member outer 50 includes a wall section 50C disposed along the center pillar outer panel 32 on a lower side of the convex section 50B.

Next, actions and effects of the vehicle side structure S28 of the first embodiment will be described.

The center pillar 16 extended along substantially the vehicle up-down direction in the side section 12 of the vehicle 10 includes the center pillar outer panel 32 disposed on an outer side in the vehicle width direction. The roof side rail 22 extended along the vehicle front-rear direction is provided on the vehicle upper side of the center pillar 16, and the roof side rail 22 includes the rail outer panel 36 disposed on an outer side in the vehicle width direction. Moreover, the inner side surface in the vehicle width direction of the flange section 40C provided in the upper section of the center pillar outer panel 32 and the outer side surface in the vehicle width direction of the outer side wall section 36B of the rail outer panel 36 are overlapped to be joined, whereby the joining section 42 is configured (formed).

The projecting section 40D configured in a shape projecting to the vehicle outer side from the joining section 42 is formed in the center pillar outer panel 32. As a result, the virtual surface 54 configured by the top (in the first embodiment, the corner 41 on the upper side) of the projecting section 40D and the ridge 37 on the vehicle upper side of the rail outer panel 36 approaches becoming parallel to the contact surface 130A of the collision testing device 130, based on a projection amount of the projecting section 40D. In the vehicle side structure S28, there is a configuration where due to the projection amount of the projecting section 40D, the virtual surface 54 is close to being substantially parallel to the contact surface 130A of the collision testing device 130. Therefore, in the vehicle side structure S28, it is more suppressed that the rail outer panel 36 undergoes rotational deformation to the vehicle inner side by being pressed by the contact surface 130A during a roof crash such as a roll over, compared to in a configuration where there is no projecting section. Therefore, it is suppressed that the center pillar 16 deforms by collapsing to an inner side in the vehicle width direction along with rotational deformation of the roof side rail 22, and load transfer efficiency to the center pillar 16 can be raised.

In addition, the projecting section 40D projecting from the joining section 42 with the roof side rail 22 of the center pillar outer panel 32 is formed along the lower end side of the joining portion 42. As a result, in the vehicle side structure S28, a distance of the virtual surface 54 configured by the top of the projecting section 40D and the ridge 37 on the vehicle upper side of the rail outer panel 36 widens more compared to in a configuration where the projecting section is provided in a part other than the lower end side of the joining section. Therefore, a deformation mode of the rail outer panel 36 when it has been pressed by the contact surface 130A of the collision testing device 130 stabilizes, and rotational deformation to the vehicle inner side of the rail outer panel 36 during a roof crash such as a roll over is more effectively suppressed.

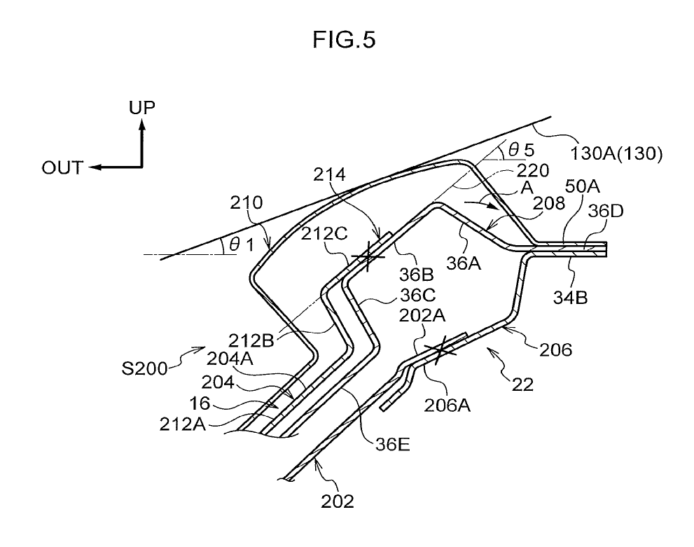

FIG. 5 shows in a cross-sectional view a vehicle side structure S200 of a comparative example. Note that configuring portions identical to those of the previously mentioned first embodiment will be assigned with identical numbers to those assigned in the previously mentioned first embodiment, and descriptions thereof will be omitted.

As shown in FIG. 5, the center pillar 16 includes a center pillar inner panel 202 and a center pillar outer panel 204. The roof side rail 22 includes a rail inner panel 206 and a rail outer panel 208. Moreover, a side member outer 210 is disposed on an outer side in the vehicle width direction of the rail outer panel 208 and the center pillar outer panel 204.

An upper end section 202A of the center pillar inner panel 202 is overlapped on to be joined by welding to an intermediate section 206A of the rail inner panel 206.

The rail outer panel 208 has its cross section configured in substantially a hat shape in a cross-sectional view along substantially the vehicle up-down direction and substantially the vehicle width direction shown in FIG. 5, and is opened inwardly orientated in the vehicle width direction. The rail outer panel 208 is formed by, for example, high tensile strength steel sheets or a hot stamp material (HS material).

An upper end section 204A of the center pillar outer panel 204 includes: a wall section 212A disposed in an oblique direction so as to be substantially more to an inner side in the vehicle width direction the more the vehicle upper side is approached; and an inclined wall section 212B extending obliquely upwardly to an outer side in the vehicle width direction from an upper end section of the wall section 212A. Furthermore, the upper end section 204A of the center pillar outer panel 204 includes a flange section 212C which is bent obliquely upwardly to an inner side in the vehicle width direction from an upper end section of the inclined wall section 212B and is overlapped on to be joined to the outer side wall section 36B of the rail outer panel 208. An inner side surface in the vehicle width direction of the flange section 212C and an outer side surface in the vehicle width direction of the outer side wall section 36B of the rail outer panel 208 are overlapped, whereby a joining section 214 is configured (formed).

In the vehicle side structure S200, an angle θ5 with respect to the horizontal direction of the joining section 214 of the rail outer panel 208 and the center pillar outer panel 204 (refer to a virtual surface 220) is larger than the angle θ1 with respect to the horizontal direction of the contact surface 130A of the collision testing device 130. For example, due to the likes of a molding requirement (for example, a mold viability requirement) of the hot stamp material, and so on, it is difficult for the angle θ5 with respect to the horizontal direction of the joining section 214 of the rail outer panel 208 and the center pillar outer panel 204 (refer to the virtual surface 220) to be made the same as the angle θ1 with respect to the horizontal direction of the contact surface 130A of the collision testing device 130.

Therefore, in the vehicle side structure S200, when the rail outer panel 208 is pressed by the contact surface 130A of the collision testing device 130, the joining section 214 with the center pillar outer panel 204 of the rail outer panel 208 undergoes rotational deformation to the vehicle inner side (that is, in an arrow A direction) until it becomes substantially parallel to the contact surface 130A of the collision testing device 130. When the roof side rail 22 undergoes rotational deformation to the vehicle inner side (that is, in the arrow A direction), the center pillar 16 also deforms by collapsing to an inner side in the vehicle width direction along with the roof side rail 22, hence a component pressing the center pillar 16 in its axial direction (the vehicle up-down direction) decreases. Therefore, there is a possibility that during a roof crash, load transfer efficiency to the high-rigidity center pillar 16 lowers and it becomes difficult to support a target load.

In contrast, in the vehicle side structure S28 of the first embodiment, as shown in FIG. 2, the projecting section 40D is configured in a shape where the virtual surface 54 configured by the corner 41 at the top of the projecting section 40D and the ridge 37 on the vehicle upper side of the rail outer panel 36 is close to being substantially parallel to the contact surface 130A of the collision testing device 130. As a result, it is suppressed that the rail outer panel 36 pressed by the contact surface 130A during a roof crash undergoes rotational deformation to the vehicle inner side. Therefore, it is suppressed that the center pillar 16 deforms by collapsing to an inner side in the vehicle width direction along with rotational deformation of the roof side rail 22, and load transfer efficiency to the center pillar 16 can be raised.

### Second Embodiment

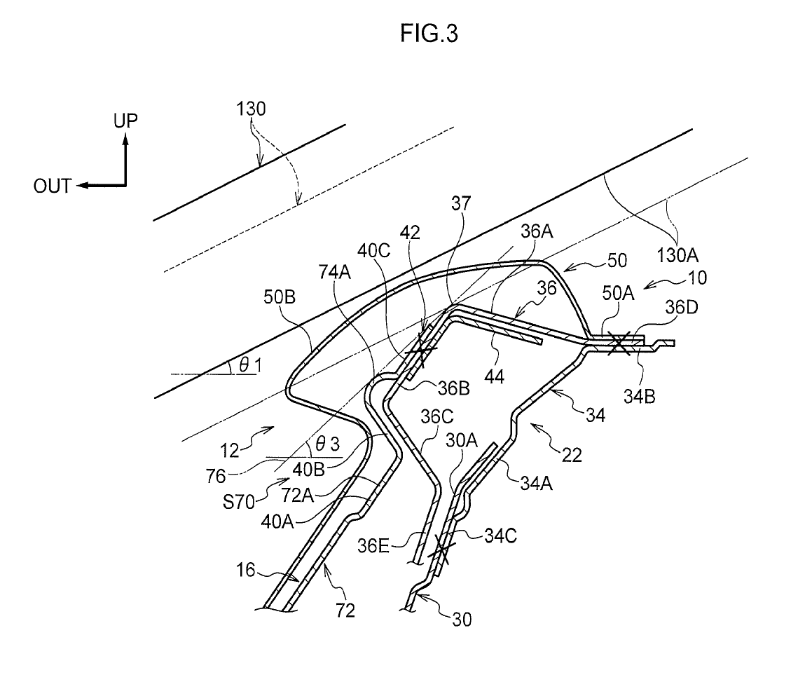

FIG. 3 shows the side section 12 of the vehicle 10 applied with a vehicle side structure S70 of a second embodiment. Note that configuring portions identical to those of the previously mentioned first embodiment will be assigned with identical numbers to those assigned in the previously mentioned first embodiment, and descriptions thereof will be omitted.

As shown in FIG. 3, in the vehicle side structure S70, an upper end section 72A of a center pillar outer panel 72 includes a projecting section 74A acting as a load transfer section configured in a shape projecting to the vehicle outer side, between the upper end of the inclined wall section 40B and the lower end section of the flange section 40C. The projecting section 74A is formed in a substantially semicircular shape, and is configured in a shape projecting toward the vehicle outer side (in the second embodiment, obliquely upwardly to an outer side in the vehicle width direction) from the lower end section of the flange section 40C. In other words, the projecting section 74A is configured in a shape projecting from the joining section 42 of the center pillar outer panel 72 and the rail outer panel 36, and is formed along the lower end side of the joining section 42.

In the vehicle side structure S70, a virtual surface 76 configured by a top of the projecting section 74A and the ridge 37 on the vehicle upper side of the rail outer panel 36 is configured such that its outer side in the vehicle width direction is to a lower side than its inner side in the vehicle width direction. At that time, the above-described virtual surface 76 is configured so as to get close to parallel to the contact surface 130A of the collision testing device 130 used in the Roof Strength Test. In FIG. 3, an angle θ3 with respect to the horizontal direction of the above-described virtual surface 76 is larger than the angle θ1 with respect to the horizontal direction of the contact surface 130A of the collision testing device 130. However, a difference between the angle θ3 of the vehicle side structure S70 and the angle θ1 is smaller than a difference between the angle θ5 with respect to the horizontal direction of the joining section 214 of the vehicle side structure S200 of the comparative example (refer to FIG. 5) and the angle θ1 with respect to the horizontal direction of the contact surface 130A of the collision testing device 130.

In the above-described vehicle side structure S70, by the projecting section 74A being provided in the center pillar outer panel 72, a timing at which the projecting section 74A contacts the contact surface 130A when a vicinity of the ridge 37 of the rail outer panel 36 is pressed by the contact surface 130A of the collision testing device 130, is earlier. As a result, in the vehicle side structure S70, rotational deformation to the vehicle inner side of the roof side rail 22 during a roof crash is suppressed more compared to in a configuration where the projecting section projecting to the vehicle outer side from the flange section 212C is not provided in the center pillar outer panel 204 as in the vehicle side structure S200 of the comparative example. Therefore, it is suppressed that the center pillar 16 deforms by collapsing to an inner side in the vehicle width direction along with rotational deformation of the roof side rail 22, and load transfer efficiency to the center pillar 16 can be raised.

In addition, the projecting section 74A projecting from the joining section 42 with the roof side rail 22 of the center pillar outer panel 72 is formed along the lower end side of the joining portion 42. As a result, in the vehicle side structure S70, a distance of the virtual surface 76 configured by the top of the projecting section 74A and the ridge 37 on the vehicle upper side of the rail outer panel 36 widens more compared to in a configuration where the projecting section is provided in a part other than the lower end side of the joining section. Therefore, a deformation mode of the rail outer panel 36 when it has been pressed by the contact surface 130A of the collision testing device 130 stabilizes, and rotational deformation to the vehicle inner side of the rail outer panel 36 during a roof crash such as a roll over is more effectively suppressed.

### Third Embodiment

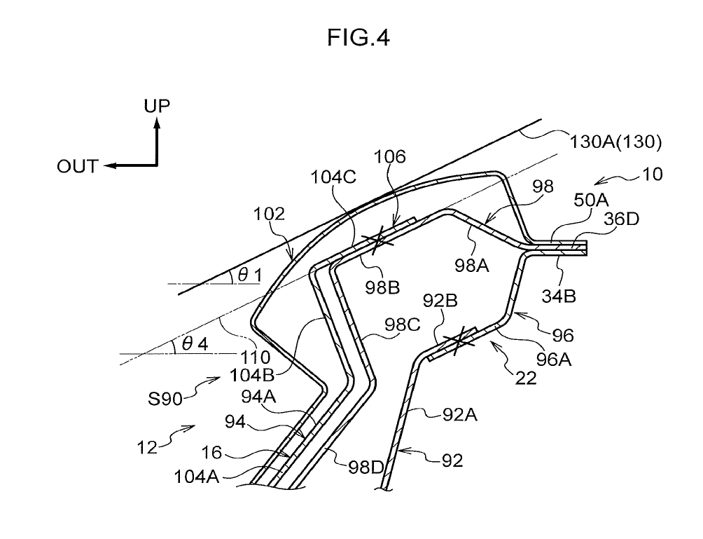

FIG. 4 shows the side section 12 of the vehicle 10 applied with a vehicle side structure S90 of a third embodiment. Note that configuring portions identical to those of the previously mentioned first and second embodiments will be assigned with identical numbers to those assigned in the previously mentioned first and second embodiments, and descriptions thereof will be omitted.

As shown in FIG. 4, in the vehicle side structure S90, the center pillar 16 includes a center pillar inner panel 92 and a center pillar outer panel 94. The roof side rail 22 includes a rail inner panel 96 and a rail outer panel 98 which acts as a roof side rail outer panel. Moreover, a side member outer 102 is disposed on an outer side in the vehicle width direction of the rail outer panel 98 and the center pillar outer panel 94.

The rail inner panel 96 is formed in substantially a crank shape. In other words, the rail inner panel 96 includes: a wall section 96A which is substantially L-shaped and projects substantially obliquely downwardly to an inner side in the vehicle width direction; and the upper flange section 34B formed in an upper end section of the wall section 96A. The center pillar inner panel 92 includes: a wall section 92A disposed such that its upper section side is more to an inner side in the vehicle width direction than its lower section side; and a flange section 92B bent substantially obliquely upwardly to an inner side in the vehicle width direction from an upper end section of the wall section 92A. The flange section 92B of the center pillar inner panel 92 is overlapped on to be joined by welding to a lower end section of the wall section 96A of the rail inner panel 96.

The rail outer panel 98 has its cross section configured as substantially a hat shape in a cross-sectional view along substantially the vehicle up-down direction and substantially the vehicle width direction shown in FIG. 4, and is opened inwardly orientated in the vehicle width direction. The rail outer panel 98 includes: an upper wall section 98A disposed such that its outer side portion in the vehicle width direction is more to an upper side than its inner side portion in the vehicle width direction; an outer side wall section 98B disposed along an obliquely downward direction to an outer side in the vehicle width direction from an end section on an outer side in the vehicle width direction of the upper wall section 98A; and a lower wall section 98C disposed along an obliquely downward direction to an inner side in the vehicle width direction from a lower end section of the outer side wall section 98B. Furthermore, the rail outer panel 98 includes: the upper flange section 36D; and a lower flange section 98D extending substantially obliquely downwardly to an outer side in the vehicle width direction from an end section on an inner side in the vehicle width direction of the lower wall section 98C. The rail outer panel 98 is formed by, for example, high tensile strength steel sheets or a hot stamp material (HS material).

An upper end section 94A of the center pillar outer panel 94 includes: a wall section 104A disposed in an oblique direction so as to be substantially more to an inner side in the vehicle width direction the more the vehicle upper side is approached; and an inclined wall section 104B extending obliquely upwardly to an outer side in the vehicle width direction from an upper end section of the wall section 104A. Furthermore, the upper end section 94A of the center pillar outer panel 94 includes a flange section 104C which is bent obliquely upwardly to an inner side in the vehicle width direction from an upper end section of the inclined wall section 104B and is overlapped on to be joined to the outer side wall section 98B of the rail outer panel 98. An inner side surface in the vehicle width direction of the flange section 104C and an outer side surface in the vehicle width direction of the outer side wall section 98B of the rail outer panel 98 are overlapped, whereby a joining section 106 is configured.

In the vehicle side structure S90, the joining section 106 of the rail outer panel 98 and the center pillar outer panel 94 is configured such that its outer side in the vehicle width direction is more to a lower side than its inner side in the vehicle width direction. At that time, the joining section 106 of the rail outer panel 98 and the center pillar outer panel 94 is configured so as to be substantially parallel to the contact surface 130A of the collision testing device 130, in vehicle front view (in vehicle rear view in FIG. 4). In other words, the joining section 106 of the rail outer panel 98 and the center pillar outer panel 94 is configured such that its angle θ4 with respect to the horizontal direction (refer to a virtual surface 110) is substantially the same as the angle θ1 with respect to the horizontal direction of the contact surface 130A of the collision testing device 130, in vehicle front view (in vehicle rear view in FIG. 4). More specifically, the angle θ4 with respect to the horizontal direction of the joining section 106 of the rail outer panel 98 and the center pillar outer panel 94 is configured to be approximately 25°. For example, due to the likes of improvement in a molding requirement (for example, a mold viability requirement) of the high tensile strength steel sheets or hot stamp material, and so on, the angle θ4 of the flange section 104C with respect to the horizontal direction of the rail outer panel 98 in the joining section 106 can be formed so as to be substantially the same as the angle θ1 with respect to the horizontal direction of the contact surface 130A of the collision testing device 130.

In the Roof Strength Test conducted by the United States Insurance Institute for Highway Safety (IIHS), the contact surface 130A of the collision testing device 130 is set to be pressed, with the angle θ1 with respect to the horizontal direction being 25°, from an outer side in the vehicle width direction toward an obliquely downward side on an inner side in the vehicle width direction of the roof side rail 22 in vehicle front view. In this case, in the vehicle side structure S90, the joining section 106 of the rail outer panel 98 and the center pillar outer panel 94 is configured so as to be substantially parallel to the contact surface 130A of the collision testing device 130 in vehicle front view. As a result, in the vehicle side structure S90, it is suppressed that the roof side rail 22 undergoes rotational deformation to the vehicle inner side by the joining section 106 of the rail outer panel 98 and the center pillar outer panel 94 being pressed by the contact surface 130A during a roof crash. Therefore, it is suppressed that the center pillar 16 deforms by collapsing to an inner side in the vehicle width direction along with rotational deformation of the roof side rail 22, and load transfer efficiency to the center pillar 16 can be raised.

[Experiment Results]

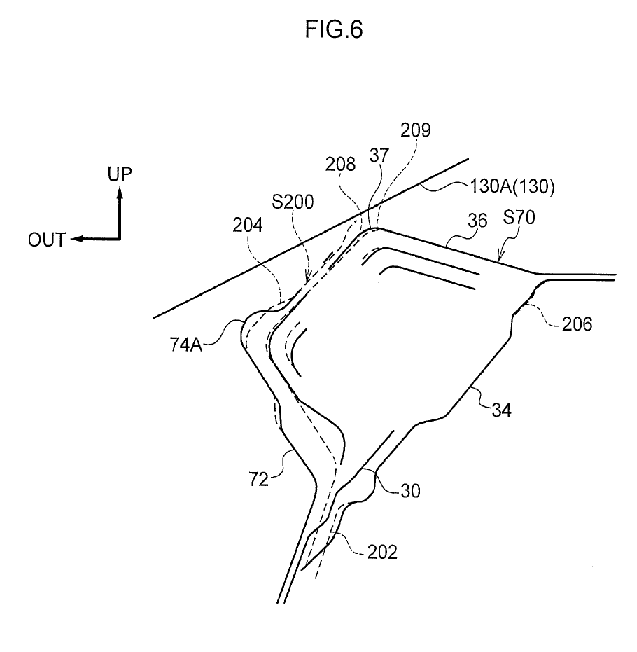

FIG. 6 is a schematic cross-sectional view comparing a first deformation state due to a collision test, in the vehicle side structure S70 of the second embodiment shown in FIG. 3 and the vehicle side structure S200 of the comparative example shown in FIG. 5. FIG. 6 shows a state where a vicinity of the ridge 37, 209 on the vehicle upper side of the rail outer panel 36, 208 has contacted the contact surface 130A of the collision testing device 130.

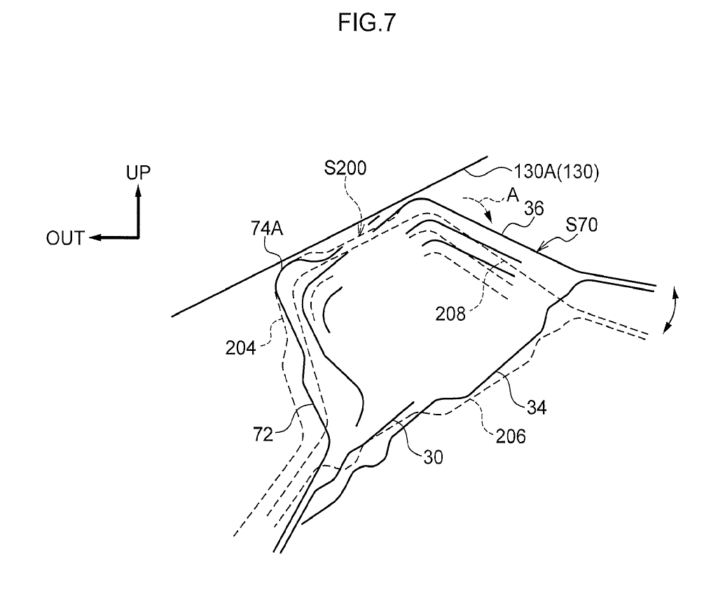

In addition, FIG. 7 is a schematic cross-sectional view comparing a second deformation state due to a collision test, in the vehicle side structure S70 of the second embodiment shown in FIG. 3 and the vehicle side structure S200 of the comparative example shown in FIG. 5. FIG. 7 shows a state where the projecting section 74A of the center pillar outer panel 72 has contacted the contact surface 130A of the collision testing device 130.

As shown in FIGS. 6 and 7, in the vehicle side structure S200 of the comparative example, the joining section 214 of the rail outer panel 208 and the center pillar outer panel 204 (refer to FIG. 5) clearly undergoes rotational deformation to the vehicle inner side (in the arrow A direction) when the rail outer panel 208 is pressed by the contact surface 130A of the collision testing device 130. In contrast, in the vehicle side structure S70 of the second embodiment, rotational deformation to the vehicle inner side of the roof side rail 22 is clearly suppressed by the projecting section 74A of the center pillar outer panel 72 abutting on the contact surface 130A of the collision testing device 130.

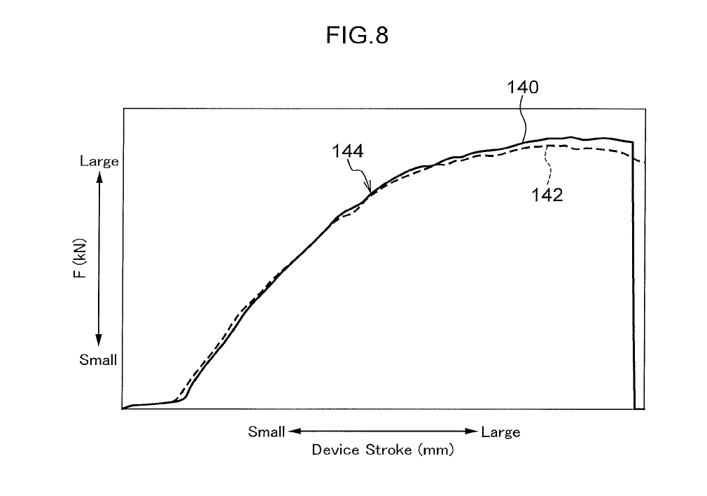

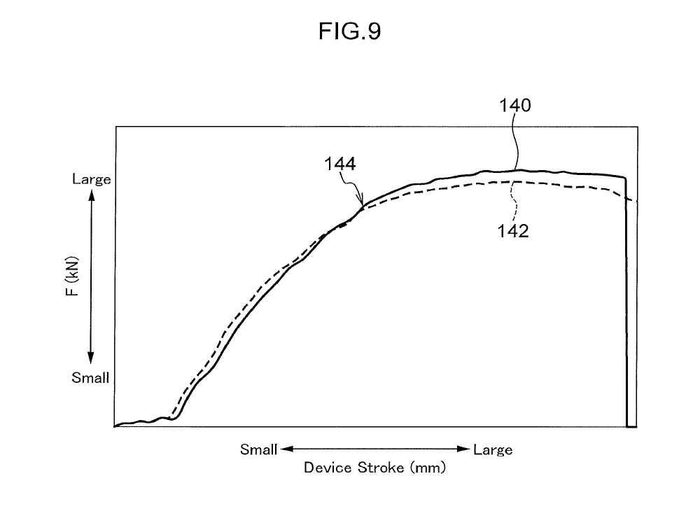

FIG. 8 is a graph comparing a relationship of a stroke of the contact surface 130A of the collision testing device 130 and a reaction force in the contact surface 130A, in the vehicle side structure S70 of the second embodiment shown in FIG. 3 and the vehicle side structure S200 of the comparative example shown in FIG. 5. In addition, FIG. 9 is a graph comparing a relationship of a stroke of the contact surface 130A of the collision testing device 130 and a load in an up-down direction of the center pillar 16, in the vehicle side structure S70 of the second embodiment shown in FIG. 3 and the vehicle side structure S200 of the comparative example shown in FIG. 5. In FIGS. 8 and 9, the solid line graph 140 indicates the vehicle side structure S70 of the second embodiment, and the broken line graph 142 indicates the vehicle side structure S200 of the comparative example. Moreover, in FIGS. 8 and 9, the arrow 144 indicates a timing at which the projecting section 74A of the center pillar outer panel 72 has abutted on the contact surface 130A of the collision testing device 130.

As shown in FIG. 8, in the vehicle side structure S70 of the second embodiment, the reaction force in the contact surface 130A of the collision testing device 130 clearly increases more by the projecting section 74A of the center pillar outer panel 72 abutting on the contact surface 130A, compared to in the vehicle side structure S200 of the comparative example. Moreover, as shown in FIG. 9, in the vehicle side structure S70 of the second embodiment, the load in the up-down direction of the center pillar 16 clearly increases more by the projecting section 74A of the center pillar outer panel 72 abutting on the contact surface 130A of the collision testing device 130, compared to in the vehicle side structure S200 of the comparative example.

Note that in the first and second embodiments, shapes, heights, and projecting directions of the projecting sections 40D, 74A of the center pillar outer panels 32, 72 may each be changed.

Moreover, in the first and second embodiments, the projecting sections 40D, 74A of the center pillar outer panels 32, 72 are formed along the lower end side of the joining section 42 with the rail outer panel 36. However, the present disclosure is not limited to this configuration. The projecting section of the center pillar outer panel may be provided in an intermediate section in the vehicle width direction of the joining section with the rail outer panel or in a part including an inner side in the vehicle width direction of the joining section with the rail outer panel.

The disclosure of Japanese Patent Application No. 2016-227084 filed on Nov. 22, 2016 is incorporated in the present specification by reference in its entirety.

All of the documents, patent applications, and technical standards described in the present specification are incorporated by reference in the present specification to the same degree as if what was incorporated by reference by the individual documents, patent applications, and technical standards was specifically and individually described.

What is claimed is:

1. A vehicle side structure, comprising:
a center pillar extended along a vehicle up-down direction at a vehicle side part, the center pillar comprising a center pillar outer panel disposed at an outer side in a vehicle width direction;
a roof side rail provided at a vehicle upper side of the center pillar, the roof side rail being extended along a vehicle front-rear direction and comprising a roof side rail outer panel disposed at an outer side in the vehicle width direction;
a joining section at which an inner side surface, in the vehicle width direction, of an upper section of the center pillar outer panel in the vehicle up-down direction, and an outer side surface of the roof side rail outer panel in the vehicle width direction, are overlapped and joined; and
a load transfer section formed at the center pillar outer panel and configured in a shape projecting toward a vehicle outer side from the joining section.

2. The vehicle side structure according to claim 1, wherein the load transfer section is configured as a projecting section projecting from the joining section and is formed along a lower end side of the joining section.

3. A vehicle side structure, comprising:
a center pillar extended along a vehicle up-down direction at a vehicle side part, the center pillar comprising a center pillar outer panel disposed at an outer side in a vehicle width direction; and
a roof side rail provided at a vehicle upper side of the center pillar, the roof side rail being extended along a vehicle front-rear direction and comprising a roof side rail outer panel disposed at an outer side in the vehicle width direction,
in a case in which, in a Roof Strength Test conducted by the United States Insurance Institute for Highway Safety, a contact surface of a collision testing device has been pressed at an angle of 25° with respect to a horizontal direction from an outer side in the vehicle width direction toward an obliquely downward side at an inner side in the vehicle width direction of the roof side rail in vehicle front view,
a joining section, at which an inner side surface, in the vehicle width direction, of an upper section of the center pillar outer panel in the vehicle up-down direction, and an outer side surface of the roof side rail outer panel in the vehicle width direction, are overlapped and joined, being configured so as to be substantially parallel to the contact surface in vehicle front view.

4. The vehicle side structure according to claim 1, wherein:
in a case in which, in a Roof Strength Test conducted by the United States Insurance Institute for Highway Safety, a contact surface of a collision testing device has been pressed at an angle of 25° with respect to a horizontal direction from an outer side in the vehicle width direction toward an obliquely downward side at an inner side in the vehicle width direction of the roof side rail in vehicle front view,
a virtual surface, configured by the load transfer section and a ridge at a vehicle upper side of the roof side rail outer panel, is configured so as to be substantially parallel to the contact surface in vehicle front view.
